(19) United States
(12) Patent Application Publication
(10) Pub. No.: US 2025/0316728 A1
(43) Pub. Date: Oct. 9, 2025

(54) PLASTIC DUCTS WITH SLIP-ON STEEL FLANGE FOR THERMAL INTERFACES

(71) Applicant: GM Global Technology Operations LLC, Detroit, MI (US)

(72) Inventors: Karthick P. Ghawalkar, Bangalore (IN); Ronald Miller, Bloomfield Hills, MI (US); Neeraj Mishra, Lucknow (IN); Manimaran Sampath, Tindivanam (IN)

(73) Assignee: GM Global Technology Operations LLC, Detroit, MI (US)

(21) Appl. No.: 18/627,107

(22) Filed: Apr. 4, 2024

(51) Int. Cl. H01M 8/04082; F16L 23/20; H01M 8/04111

(52) U.S. Cl. CPC H01M 8/04216; F16L 23/20; H01M 8/04111; H01M 2250/20

(57) ABSTRACT

A duct assembly includes a metallic flange having a first side, a second side opposite the first side, and a projection extending from the second side. An inner surface of the metallic flange extends between the first side and an end of the projection distal from the second side of the metallic flange to define a flange passageway. The first side of the metallic flange is configured to join to a metallic mounting surface of a vehicular component when the duct assembly is mounted at the vehicular component. The duct assembly also includes a plastic duct received at the projection of the metallic flange and having a duct passageway in fluid communication with the flange passageway. The duct passageway is configured to fluidly communicate with the vehicular component via the flange passageway when the duct assembly is mounted at the vehicular component.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a seal formed between vehicular components that withstands thermal changes during operation of the components and/or transfer of material between the components. Specifically, the present disclosure provides a plastic duct that joins to a metallic flange for interfacing with a metallic mounting surface of a compressor, where the duct carries ambient air to the compressor. The compressor generates heat during operation and the metallic flange resists thermal transfer from the compressor to the plastic duct.

Vehicular components generate heat and often transfer this heat to other components or systems of the vehicle that are in thermal connection with the heat generating vehicular component, such as by carrying heated, ambient, or cooled fluid (i.e., air) to and/or from the vehicular component. These vehicular components are often formed from a metallic material, while ducts and hoses connected to the vehicular components for carrying the fluid or gas to and/or from the components are often formed from a rubber or plastic material with reduced thermal resistance compared to the metallic material of the vehicular component. Traditionally, plastic ducts are joined to metallic vehicular components using elastomeric press-in-place (PIP) seals or other rubberized seals. Over the life of the system, prolonged heat exposure can degrade these rubberized seals and plastic ducts.

### SUMMARY

One aspect of the disclosure provides a duct assembly. The duct assembly includes a metallic flange having a first side, a second side opposite the first side, and a projection extending from the second side. An inner surface of the metallic flange extends between the first side and an end of the projection distal from the second side of the metallic flange to define a flange passageway. The first side of the metallic flange is configured to join to a metallic mounting surface of a vehicular component when the duct assembly is mounted at the vehicular component. The duct assembly also includes a plastic duct received at the projection of the metallic flange. The plastic duct has a duct passageway in fluid communication with the flange passageway. The duct passageway is configured to fluidly communicate with the vehicular component via the flange passageway when the duct assembly is mounted at the vehicular component.

Implementations of the disclosure may include one or more of the following optional features. In some examples, the plastic duct is received along the projection of the metallic flange at an outer surface of the metallic flange that is opposite the inner surface of the metallic flange. In further examples, the duct assembly includes an O-ring disposed between the outer surface of the metallic flange and an inner surface of the plastic duct. In other further examples, the duct assembly includes a first O-ring and a second O-ring respectively disposed between the outer surface of the metallic flange and an inner surface of the plastic duct. The first O-ring and the second O-ring are axially spaced from one another along the projection of the plastic flange. In other further examples, the duct assembly includes a clamp disposed at the plastic duct along the projection of the metallic flange, securing the duct at the metallic flange.

In some implementations, the plastic duct is received along the projection of the metallic flange at the inner surface of the metallic flange.

In some examples, the duct assembly includes a mechanical fastener extending through the metallic flange and received at the vehicular component to secure the duct assembly at the vehicular component when the duct assembly is mounted at the vehicular component.

In some aspects, the duct assembly includes a metallic gasket disposed between the first side of the metallic flange and the mounting surface of the vehicular component when the duct assembly is mounted at the vehicular component.

In some examples, the metallic flange is configured to join to the metallic mounting surface at one selected from the group consisting of (i) an inlet of the vehicular component and (ii) an outlet of the vehicular component.

In some implementations, the vehicular component includes a compressor of a fuel cell system of a vehicle.

Another aspect of the disclosure provides a fuel cell system. The fuel cell system includes a component that generates heat during operation of the fuel cell system. The component includes a metallic mounting surface. The fuel cell system also includes a duct assembly. The duct assembly includes a metallic flange having a first side, a second side opposite the first side, and a projection extending from the second side. An inner surface of the metallic flange extends between the first side and an end of the projection distal from the second side of the metallic flange to define a flange passageway. The first side of the metallic flange is configured to join to a metallic mounting surface of the component when the duct assembly is mounted at the component. The duct assembly also includes a plastic duct received at the projection of the metallic flange and having a duct passageway in fluid communication with the flange passageway. The duct passageway is configured to fluidly communicate with the component via the flange passageway when the duct assembly is mounted at the component.

Implementations of this aspect of the disclosure may include one or more of the following optional features. In some examples, the plastic duct is received along the projection of the metallic flange at an outer surface of the metallic flange that is opposite the inner surface of the metallic flange. In further examples, the fuel cell system includes an O-ring disposed between the outer surface of the metallic flange and an inner surface of the plastic duct. In other further examples, the fuel cell system includes a clamp disposed at the plastic duct along the projection of the metallic flange and securing the plastic duct at the metallic flange.

In some implementations, the fuel cell system includes a metallic gasket disposed between the first side of the metallic flange and the mounting surface of the component when the duct assembly is mounted at the component.

Yet another aspect of the disclosure provides a vehicle. The vehicle includes a fuel cell system. The fuel cell system includes a compressor that generates heat during operation of the fuel cell system. The compressor includes a metallic mounting surface. The fuel cell system also includes a duct assembly. The duct assembly includes a metallic flange having a first side, a second side opposite the first side, and a projection extending from the second side. An inner surface of the metallic flange extends between the first side and an end of the projection distal from the second side of the metallic flange to define a flange passageway. The first side of the metallic flange is configured to join to a metallic mounting surface of the compressor when the duct assembly is mounted at the compressor. The duct assembly also includes a plastic duct received at the projection of the metallic flange and having a duct passageway in fluid communication with the flange passageway. The duct passageway is configured to fluidly communicate with the compressor via the flange passageway when the duct assembly is mounted at the compressor.

Implementations of this aspect of the disclosure may include one or more of the following optional features. In some examples, the plastic duct is received along the projection of the metallic flange at an outer surface of the metallic flange that is opposite the inner surface of the metallic flange. In further examples, the vehicle includes an O-ring disposed between the outer surface of the metallic flange and an inner surface of the plastic duct. In other further examples, the vehicle includes a clamp disposed at the duct along the projection of the metallic flange and securing the plastic duct at the metallic flange.

In some implementations, the vehicle includes a metallic gasket disposed between the first side of the metallic flange and the mounting surface of the compressor when the duct assembly is mounted at the compressor.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a perspective view of a duct assembly mounted to a vehicular component.

FIG. 2 is a cross-sectional view of the duct assembly and vehicular component of FIG. 1.

FIG. 3 is another cross-sectional view of the duct assembly and vehicular component of FIG. 1, including a temperature gradient representative of example temperatures experienced at the duct assembly and vehicular component during operation of the vehicular component.

FIG. 4 is a top-side view of a gasket disposed between a flange of the duct assembly and the vehicular component, including a temperature gradient representative of example temperatures experienced at the gasket during operation of the vehicular component.

FIG. 5 is a cross-sectional view of O-rings disposed within the duct assembly of FIG. 1.

FIG. 6 is another perspective view of the duct assembly and vehicular component of FIG. 1 with a duct of the duct assembly removed from the flange.

FIG. 7 is a perspective view of the flange of the duct assembly.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc, may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit,” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

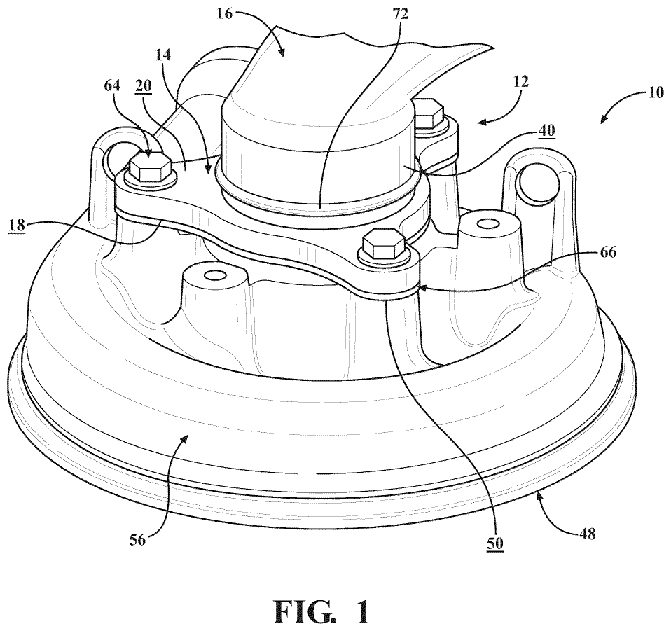

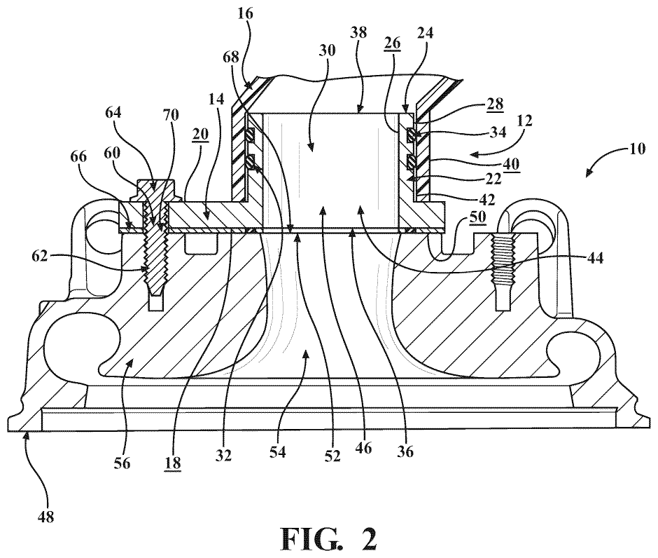

With reference to FIGS. 1 and 2, a vehicular system 10, such as a fuel cell system for powering a propulsion system of a vehicle (e.g., a passenger vehicle, a commercial vehicle, etc.), includes a duct assembly 12 that includes a metallic flange 14 and a plastic duct 16. As described further below, the duct assembly 12 is configured to transfer material (e.g., air, coolant, oil, etc.) to or from a component of the vehicular system 10 that generates heat during operation while resisting or at least partially shielding heat transfer from the heated component to the duct assembly 12. The duct 16 is formed from a plastic or rubber material (e.g., a thermoplastic material such as polyvinyl chloride (PVC), polycarbonate (PC), and acrylonitrile butadiene styrene (ABS)) having good flexibility and formability, so as to accommodate packaging constraints and reduce weight at the vehicular system 10. The metallic flange 14 is disposed at an interface between the duct assembly 12 and the component of the vehicular system 10 to at least partially shield the plastic duct 16 from the thermal output of the component. For example, the metallic flange 14 may be formed from machined steel or aluminum, or any suitable material configured to withstand temperatures at the component of the system 10 of up to 200 degrees Celsius or more, such as up to 450 degrees Celsius or more. Thus, addition or attachment of the metallic flange 14 to the plastic duct 16 allows the duct assembly 12 to accommodate packaging constraints while resisting thermal transfer from the vehicular component. Although described herein as relating to fuel cell systems, it should be understood that aspects of the duct assembly 12 may be suitable for use with any vehicular system exhausting or inletting material away from or to a heat generating component.

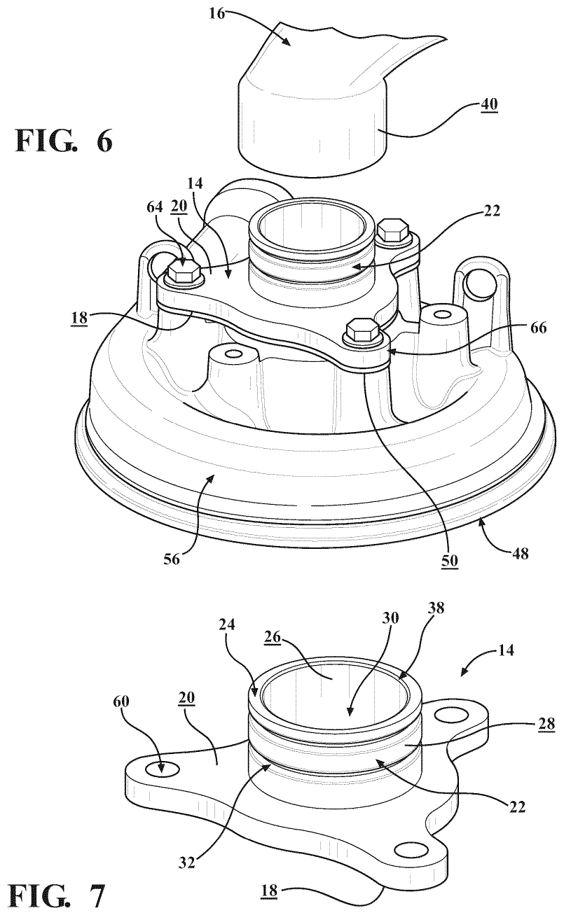

With continued reference to FIGS. 1 and 2, and also with reference to FIGS. 6 and 7, the flange 14 includes a first side 18 and a second side 20 opposite the first side 18, where the first side 18 may include or provide a planar mounting surface. Additionally, the flange 14 includes a projection 22 that extends perpendicularly from the second side 20 of the flange 14, the projection 22 terminating at an end 24 that is distal from the second side 20 of the flange 14. An inner surface 26 of the flange 14 extends between the first side 18 and the second side 20 of the flange 14 and along the projection 22 to define a flange passageway 30. An outer surface 28 of the flange 14 opposite the inner surface 26 includes a pair of recesses 32 formed along the projection 22. Each recess 32 receives an O-ring or gasket 34. The pair of recesses 32 and, thus, the respective O-rings 34, are axially spaced from one another along the projection 22 (i.e., along a longitudinal axis of the projection 22 that is parallel to a longitudinal axis of the flange passageway 30). When the duct 16 is disposed at the flange 14, the duct 16 is slipped over and along the projection 22 and the O-rings 34 may be compressed between the duct 16 and the projection 22 to retain the duct 16 along the projection 22. The O-ring 34 is formed from a rubber or conformable plastic or similar material that can act as a sealant during operation of the system 10, the function of which will be described in greater detail below. A lower flange opening 36 is formed at the first side 18 of the flange 14 at a first end of the flange passageway 30 and an upper flange opening 38 is formed at the end of the projection 22 distal from the second side 20 of the flange 14 at a second end of the flange passageway 30.

The plastic duct 16 includes an outer surface 40 and an inner surface 42 opposite the outer surface 40). The inner surface 42 defines a duct passageway 44 that extends from a duct opening 46 at an end of the duct 16. When the duct 16 is disposed at the flange 14, the duct 16 is slipped over the projection 22 so that the inner surface 42 of the duct 16 extends along the outer surface 28 of the projection 22, and the projection 22 may be fully encompassed by the duct 16. In the illustrated example of FIGS. 1-3, the duct 16 has a cylindrical inner surface 42 corresponding to a cylindrical outer surface 28 of the projection 22 to allow for simple attachment and detachment of the duct 16 and the flange 14. However, it should be understood that the duct 16 and the projection 22 may include any shape that allows for attachment and detachment of the duct 16 and the flange 14 and the passage of fluidic material through the duct passageway 44 and the flange passageway 30. For example, the duct 16 and the projection 22 may include an oval shape or a polygonal shape that can be used to align the duct 16 and the projection 22 via alignment of sides of the inner surface 42 of the duct 16 and the outer surface 28 of the projection 22. The shape of the duct 16 and the projection 22 correspond to one another to allow the inner surface 42 of the duct 16 to securely fit over the outer surface 28 of the projection 22. Furthermore, the clearance between the inner surface 42 of the duct 16 and the outer surface 28 of the projection 22 may be minimal to allow the O-rings 34 to seal the duct 16 and the flange 14, preventing the duct assembly 12 from leaking fluidic material between the duct 16 and the flange 14 as well as snuggly securing the duct 16 to the projection 22. Additionally, the duct 16 may be received along the projection 22 such that the end of the duct 16 at the duct opening 46 engages the second side 20 of the flange 14.

Optionally, the duct 16 may be received along the passageway 30 of the flange 14 along the projection 22. In other words, the outer surface of the duct 16 may extend along the inner surface of the projection 22 and fluidly connect the flange passageway and the passageway of the duct 16. For example, the O-rings 34 may be disposed in recesses formed at the inner surface of the projection 22 and engage the outer surface of the duct 16.

When the duct assembly 12 is installed or mounted at the vehicular system 10, the first side 18 of the flange 14 is joined to or coupled to a vehicular component 48 of the system 10, such as a turbo compressor volute or similar component of a fuel cell system. Furthermore, the vehicular component 48 includes a planar mounting or top surface 50 formed from a metallic material, such as machined steel or aluminum. A component opening 52 is formed at the mounting surface 50 and is in fluid communication with a chamber or passageway 54 within a body 56 of the vehicular component 48. With the duct assembly 12 mounted to the vehicular component 48, the duct passageway 44 is in fluid communication with the chamber 54 of the vehicular component 48 via the component opening 52 at the mounting surface 50 of the vehicular component 48, the lower flange opening 36, the duct opening 46, the flange passageway 30, and the upper flange opening 38. Thus, during operation of the system 10, the vehicular component 48 inlets or exhausts material via the duct assembly 12.

As shown in FIGS. 1 and 2, the flange 14 extends perpendicularly outboard of the duct 16. Furthermore, the flange 14 may include one or more mounting holes 60 that, when the duct assembly 12 is mounted at the vehicular component 48, align with corresponding fastener cavities or threaded receiving portions 62 of the vehicular component 48. Each mounting hole 60 and fastener cavity 62 is configured to accept a mechanical fastener 64, such as a bolt or a screw. When the mechanical fastener 64 extends through the mounting hole 60 and is received at the fastener cavity 62, the mechanical fastener 64 fixedly mounts the flange 14 to the vehicular component 48. As the mechanical fastener 64 is tightened to clamp the duct assembly 12 between the vehicular component 48 and a head of the mechanical fastener 64, the clamping load is transferred through the flange 14, as its metallic properties are able to withstand the clamping force without damage or deformation. With the flange 14 mounted to the vehicular component 48, the duct 16 may be installed and removed from the flange 14 by slipping the duct 16 on and off the projection 22. When the duct 16 is disposed along the projection 22, the O-rings 34 retain the duct 16 at the flange 14.

With continued reference to FIGS. 1 and 2, a metallic gasket 66, such as a single layer stainless steel (SLS) gasket or a multilayer stainless steel (MLS) gasket, is disposed between the first side 18 of the flange 14 (i.e., a metallic planar surface) and the mounting surface 50) of the vehicular component 48 (i.e., a metallic planar surface). With the duct assembly 12 mounted to the vehicular component 48, the gasket 66 is compressed between the flange 14 and the mounting surface 50 of the vehicular component 48 to form a sealed fluid connection between the duct passageway 44 and the chamber 54 of the vehicular component 48. The steel gasket 66 includes a center hole or opening 68 that, with the duct assembly 12 mounted to the vehicular component 48, may align with the lower flange opening 36 and the component opening 52 at the mounting surface 50, with the center hole 68 corresponding to the size of the lower flange opening 36 and the component opening 52. Furthermore, the steel gasket 66 includes one or more fastener holes 70 configured to align with the corresponding mounting hole 60 and fastener cavity 62 and configured to receive the mechanical fastener 64. As the mechanical fastener 64 is tightened into the duct assembly 12 and the vehicular component 48, forcing the duct assembly 12 and vehicular component 48 into a greater level of compression with one another, the force of the mechanical fastener 64 will be applied to the metallic flange 14 and the vehicular component 48, both metallic, and both resilient to deformation from the compression force applied by the mechanical fastener 64. Additionally, the compression force that may be applied to the duct assembly 12 and vehicular component 48 via the mechanical fastener 64 allows the steel gasket 66 to form a tight seal to prevent fluidic matter from escaping between the duct assembly 12 and the vehicular component 48.

With reference now to FIGS. 1, 3, and 6, the duct passageway 44, the flange passageway 30, and the chamber 54 are fluidly sealed when the duct assembly 12 is installed at the vehicular component 48. The steel gasket 66 is compressed between the first side 18 of the flange 14 and the top surface 50 of the vehicular component 48. With the first side 18 and the top surface 50 both being metallic planar surfaces, compression of the steel gasket 66 between the first side 18 and the top surface 50 creates a fluidic seal between the duct assembly 12 and the vehicular component 48 when the mechanical fasteners 64 are installed. Installing the plastic duct 16 over the projection 22 of the metallic flange 14 allows for reduced weight and improved packaging of the vehicular system 10 due to the plastic duct 16 being formed from a lightweight and flexible material compared to the materials of the flange 14 and the vehicular component 48. Further, the metallic flange 14 may be mounted to the vehicular component 48 during a first manufacturing or assembly step and the plastic duct 16 may be installed at the projection 22 at a later, second manufacturing or assembly step. This allows for greater accessibility to the mechanical fasteners 64 during tightening and allows for greater accessibility to other components near the vehicular component 48 before the duct 16 is added.

The incorporation of the steel gasket 66 and metallic flange 14 allows the duct assembly 12 to withstand high temperatures that may be present during operation of the vehicular system 10 while maintaining sealing durability requirements. That is, use of a steel gasket 66 between metallic mounting surfaces improves durability of the seal while reducing thermal exchange between the vehicular component 48 and the plastic duct 16. Furthermore, the steel gasket 66 is not prone to significant creep and deformation when exposed to high temperatures. When cold temperatures are present in the duct assembly, a seal is still maintained at the steel gasket 66. When the mechanical fasteners 64 are installed, the steel gasket 66 may be compressed to accommodate the sealing pressure requirements of the duct assembly 12 and the vehicular component 48 without experiencing deformation or other failure. The sealing pressure and durability of the steel gasket 66 is maintained between the duct assembly 12 and vehicular component 48 for transfer of gas and/or liquid between the duct assembly 12 and the vehicular component 48 via the duct passageway 44, the flange passageway 30, and the chamber 54.

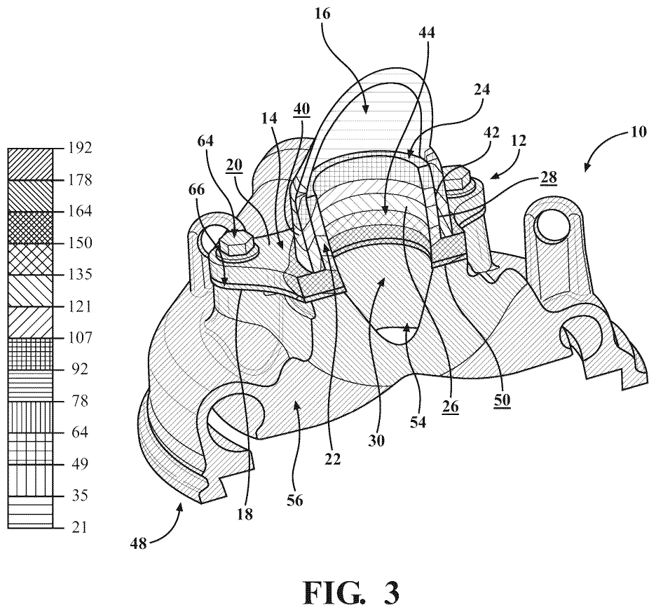

Continuing with the example of the vehicular component 48 being a compressor volute within a fuel cell system, during operation of the fuel cell system 10, ambient air flows into the duct passageway 44, passing through the component opening 52, and into the compressor 48. The compressor 48 generates heat during operation, and the heat may be thermally transferred to the flange 14 of the duct assembly 12. For example, heat generation may occur during operation of the compressor 48 to compress the air received from the duct assembly 12. As the air is compressed, the air and the compressor 48 are heated and engagement of the compressor 48 with the gasket 66 and/or duct assembly 12 transfers heat toward the flange 14 and the gasket 66. Maintaining sealing pressure between the flange 14 and the compressor 48 during operation of the compressor 48 prevents air from escaping from between the duct assembly 12 and the compressor 48 as it travels from the duct passageway 44. As shown in FIG. 3, the steel gasket 66 and the metallic flange 14 act as a thermal shield between the compressor 48 and the duct 16. In the illustrated example, while the compressor 48 may reach temperatures exceeding 192 degrees Celsius during operation, the plastic duct 16 may stay at 21 degrees Celsius or less. High temperatures may risk damage to plastic components, such as the duct 16 and, thus, are dissipated or shielded from the duct 16 to increase longevity and prevent risks of failure. Properties of the steel gasket 66 and the metallic flange 14 between the vehicular component 48 and the duct 16, such as the metallic composition of the gasket 66 and flange 14 or the thickness of the metallic flange 14, may be optimized to allow the gasket 66 and flange 14 to act as thermal shields between the compressor 48 and the duct 16 and preclude heat transfer from the heated compressor 48. Because of this, the heat experienced by the duct 16 is significantly reduced compared to the heat present at the vehicular component 48 and the integrity of the seal between the gasket 66, the compressor 48, and the flange 14 is maintained.

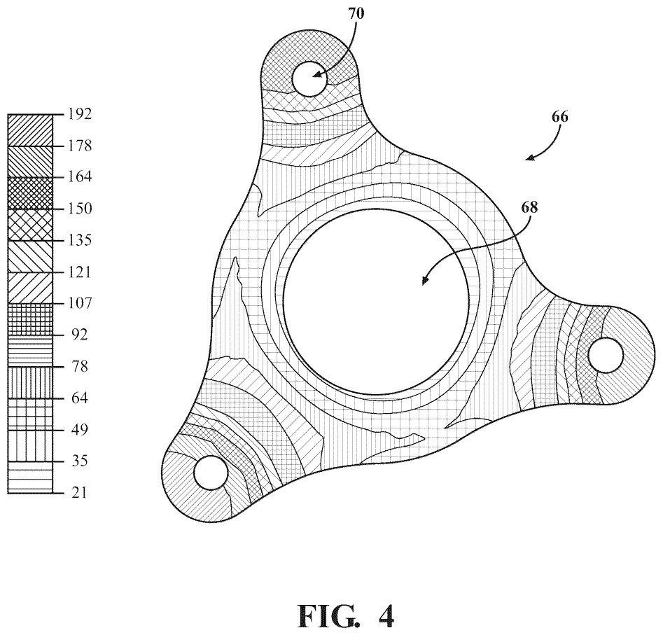

As shown in FIG. 4, during operation of the fuel cell system 10, the gasket 66 may attenuate thermal transfer between the vehicular component 48 and the flange 14. As shown, the temperature of the gasket 66 may be at its greatest at or near the fastener holes 70, due to the mechanical fasteners 64 being in direct contact with the heated vehicular component 48. Between the fastener holes 70 and the center hole 68, the temperature of the gasket 66 reduces until the lowest temperature is experienced at or near the center hole 68. Thus, exposure of the duct 16 to heat generated by the vehicular component 48 is reduced or prevented all-together. The metallic flange 14 and the steel gasket 66 act as thermal shields to prevent the plastic duct 16 from experiencing thermal transfer, preventing deformation and extending the lifespan of the duct 16 and, therefore, the entire duct assembly 12.

The steel gasket 66 also allows for a significant amount of compression to be applied in forming the seal without failure and deformation of the gasket 66, allowing the duct assembly 12 to be applied to high heat and high pressure systems.

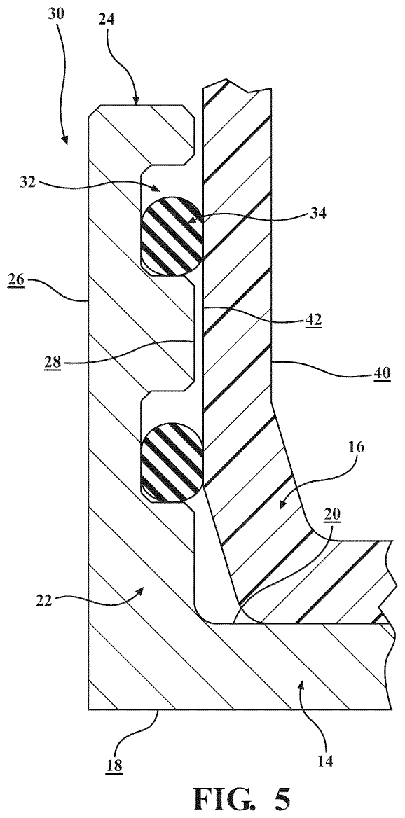

With reference now to FIG. 5, the one or more recesses 32 disposed on the outer surface 28 of the projection 22 accommodate the respective O-rings 34 that seal and retain the duct 16 at the projection 22. The O-rings 34, being a conformable plastic, rubber, or similar material, compress and flex within the recesses 32 to accommodate gap tolerances between the outer surface 28 of the projection 22 and the inner surface 42 of the duct 16. The O-rings 34 may be any suitable size such that the O-rings 34 are accommodated in the recesses 32 and seal the projection 22 to the duct 16. Further, with reference to FIG. 1, an external clamp 72 may be applied to the duct 16 to increase the sealing force of the duct 16 against the projection 22. That is, the clamp 72 is disposed at the duct 16 along the projection 22 of the flange 14 to further secure the duct 16 at the flange 14.

Slipping the plastic duct 16 over the metallic flange 14, combined with O-rings 34 disposed between the outer surface 28 of the projection 22 and the inner surface 42 of the duct 16, seals the duct 16 to the flange 14. The steel gasket 66 is disposed between the top surface 50 of the vehicular component 48 and the first side 18 of the metallic flange 14, and both the top surface 50 and the first side 18 provide planar surfaces. Mechanical fasteners 64 connect the duct assembly 12 to the vehicular component 48, allowing the steel gasket 66 to seal the chamber 54 of the vehicular component 48 and the duct passageway 44 of the duct 16. When sealed, pressurized and heated, ambient, or cooled gas and/or liquid may travel between the vehicular component 48 and the duct 16 without escaping. The use of the metallic flange 14 and the steel gasket 66 allows the duct assembly 12 to experience high pressure and high or low temperatures without risking failure. Furthermore, the metallic flange 14 and the steel gasket 66 act as thermal shields between the vehicular component 48 and the duct 16, preventing the plastic material of the duct 16 from deforming or failing due to extreme temperatures.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A duct assembly comprising:
a metallic flange having a first side, a second side opposite the first side, and a projection extending from the second side, an inner surface of the metallic flange extending between the first side and an end of the projection distal from the second side of the metallic flange to define a flange passageway, the first side of the metallic flange configured to join to a metallic mounting surface of a vehicular component when the duct assembly is mounted at the vehicular component; and
a plastic duct received at the projection of the metallic flange and having a duct passageway in fluid communication with the flange passageway, the duct passageway configured to fluidly communicate with the vehicular component via the flange passageway when the duct assembly is mounted at the vehicular component.

2. The duct assembly of claim 1, wherein the plastic duct is received along the projection of the metallic flange at an outer surface of the metallic flange that is opposite the inner surface of the metallic flange.

3. The duct assembly of claim 2, further comprising an O-ring disposed between the outer surface of the metallic flange and an inner surface of the plastic duct.

4. The duct assembly of claim 2, further comprising a first O-ring and a second O-ring respectively disposed between the outer surface of the metallic flange and the inner surface of the plastic duct, the first O-ring and the second O-ring axially spaced from one another along the projection of the metallic flange.

5. The duct assembly of claim 2, further comprising a clamp disposed at the plastic duct along the projection of the metallic flange and securing the duct at the metallic flange.

6. The duct assembly of claim 1, wherein the plastic duct is received along the projection of the metallic flange at the inner surface of the metallic flange.

7. The duct assembly of claim 1, further comprising a mechanical fastener extending through the metallic flange and received at the vehicular component to secure the duct assembly at the vehicular component when the duct assembly is mounted at the vehicular component.

8. The duct assembly of claim 1, further comprising a metallic gasket disposed between the first side of the metallic flange and the mounting surface of the vehicular component when the duct assembly is mounted at the vehicular component.

9. The duct assembly of claim 1, wherein the metallic flange is configured to join to the metallic mounting surface at one selected from the group consisting of (i) an inlet of the vehicular component and (ii) an outlet of the vehicular component.

10. The duct assembly of claim 1, wherein the vehicular component comprises a compressor of a fuel cell system of a vehicle.

11. A fuel cell system comprising:
a component that generates heat during operation of the fuel cell system, the component comprising a metallic mounting surface; and
a duct assembly comprising:
a metallic flange having a first side, a second side opposite the first side, and a projection extending from the second side, an inner surface of the metallic flange extending between the first side and an end of the projection distal from the second side of the metallic flange to define a flange passageway, the first side of the metallic flange configured to join to a metallic mounting surface of the component when the duct assembly is mounted at the component; and
a plastic duct received at the projection of the metallic flange and having a duct passageway in fluid communication with the flange passageway, the duct passageway configured to fluidly communicate with the component via the flange passageway when the duct assembly is mounted at the component.

12. The fuel cell system of claim 11, wherein the plastic duct is received along the projection of the metallic flange and at an outer surface of the metallic flange that is opposite the inner surface of the metallic flange.

13. The fuel cell system of claim 12, further comprising an O-ring disposed between the outer surface of the metallic flange and an inner surface of the plastic duct.

14. The fuel cell system of claim 12, further comprising a clamp disposed at the plastic duct along the projection of the metallic flange and securing the plastic duct at the metallic flange.

15. The fuel cell system of claim 11, further comprising a metallic gasket disposed between the first side of the metallic flange and the mounting surface of the component when the duct assembly is mounted at the component.

16. A vehicle comprising:
a fuel cell system, the fuel cell system comprising:
a compressor that generates heat during operation of the fuel cell system, the compressor comprising a metallic mounting surface; and
a duct assembly comprising:
a metallic flange having a first side, a second side opposite the first side, and a projection extending from the second side, an inner surface of the metallic flange extending between the first side and an end of the projection distal from the second side of the metallic flange to define a flange passageway, the first side of the metallic flange configured to join to a metallic mounting surface of the compressor when the duct assembly is mounted at the compressor; and
a plastic duct received at the projection of the metallic flange and having a duct passageway in fluid communication with the flange passageway, the duct passageway configured to fluidly communicate with the compressor via the flange passageway when the duct assembly is mounted at the compressor.

17. The vehicle of claim 16, wherein the plastic duct is received along the projection of the metallic flange and at an outer surface of the metallic flange that is opposite the inner surface of the metallic flange.

18. The vehicle of claim 17, further comprising an O-ring disposed between the outer surface of the metallic flange and an inner surface of the plastic duct.

19. The vehicle of claim 17, further comprising a clamp disposed at the duct along the projection of the metallic flange and securing the plastic duct at the metallic flange.

20. The vehicle of claim 16, further comprising a metallic gasket disposed between the first side of the metallic flange and the mounting surface of the compressor when the duct assembly is mounted at the compressor.
